(19) United States
(12) Patent Application Publication
(10) Pub. No.: US 2011/0299042 A1
(43) Pub. Date: Dec. 8, 2011

(54) AIR FILTER DEVICE AND VIDEO PROJECTOR USING AIR FILTER DEVICE

(75) Inventors: Yosuke Nishihata, Hirakata-shi (JP); Akira Miyanaga, Daito-shi (JP); Yoshiharu Arioka, Osaka-shi (JP)

(73) Assignee: SANYO ELECTRIC CO., LTD., Osaka (JP)

(21) Appl. No.: 13/153,924

(22) Filed: Jun. 6, 2011

(30) Foreign Application Priority Data
Jun. 8, 2010 (JP) 2010-131292

(51) Int. Cl. G03B 21/16; B01D 46/42

(52) U.S. Cl. 353/52; 55/289

(57) ABSTRACT

An air filter device for a video projector, which includes a light source lamp having an optical axis and which is used in a state in which the optical axis of the light source lamp is horizontal. The air filter device includes an air filter and a cleaner that cleans the air filter. The cleaner includes a rotation brush rotated about a rotation axis to remove dust from the air filter while moving along an upstream side of the air filter. The rotation brush moves in a direction parallel to the optical axis of the light source lamp. A dust box receives dust removed from the rotation brush. The dust box includes an elongated container, which extends parallel to the rotation axis of the rotation brush, and a dust inlet, which opens toward the rotation brush to receive the dust from the rotation brush.

### CROSS-REFERENCE TO RELATED APPLICATIONS

This application is based upon and claims the benefit of priority from prior Japanese Patent Application No. 2010-131292, filed on Jun. 8, 2010, the entire contents of which are incorporated herein by reference.

### BACKGROUND OF THE INVENTION

The present invention relates to an air filter device and a video projector that uses the air filter device.

A video projector uses air to cool optical system elements such as a light source lamp or a light valve. Ambient air is used as such cooling air. Such a video projector includes an outer case provided with an air inlet through which ambient air is drawn into the projector. However, when dust is suspended in intake air, the dust may collect on optical elements such as liquid crystal panels and thereby lower the image quality. Thus, an air filter is arranged in the air inlet to capture dust from the air.

When used over a long period of time, the air filter arranged in the air inlet clogs. When the air filter clogs, the air intake resistance of the air inlet increases and the amount of air drawn through the air filter becomes insufficient. This adversely affects the effect for cooling components, such as the light source lamp and liquid crystal panels. Thus, the air filter should be frequently cleaned to prevent clogging. However, cleaning is troublesome since the air filter has to be removed from the projector. In particular, a video projector may be set not only in a frontward projecting position but also in an upward projecting position or a downward projecting position. Thus, the cleaning of the air filter may be difficult depending on the location or state in which the video projector is set. Accordingly, an air filer device has been developed to clean the air filter in a state coupled to the video projector. This air filter device allows for the frequency in which cleaning is performed, such as replacement and cleaning of the air filter.

Japanese Laid-Open Patent Publication No. 2008-65021 (hereinafter referred to as the '021 publication) describes a prior art example of an air filter device arranged in a video projector. A filter unit is arranged in an air inlet to automatically clean a pre-filter. The filter unit is removable from the outer side. In addition to the pre-filter, the filter unit includes a mechanical drive unit, brushes, and a second air filter. The pre-filter moves in a fixed direction along an air intake plane during cleaning. The mechanical drive unit moves the pre-filter. The brushes are arranged at upstream and downstream sides of the pre-filter to remove dust from the pre-filter. The second air filter captures fine particles of dust. The brushes are arranged in the middle of a moving range of the pre-filter. Further, the brushes extend perpendicular to the movement direction of the pre-filter.

An air filter device that cleans an air filter without the need for removal of the air filter has been developed for air conditioner. An air filter of an air conditioner also clogs when used over a long period of time. When the air filter clogs, the air intake resistance of an air inlet increases. This decreases the amount of the intake air and lowers the air conditioning capability. Thus, the air filter for an air conditioner must also be frequently changed to prevent clogging. However, the removal of the air filter from the air conditioner for cleaning is troublesome. Thus, in the same manner as the video projector described above, a device that cleans the air filter without the need for removal of the air filter has been developed. Japanese Laid-Open Patent Publication 2009-82837 (hereinafter referred to as the '837 publication) described a prior art example of an air filter device for an air conditioner.

The air filter device of the '837 publication includes an air filter and a rotation brush (rotation cleaner). The air filter captures dust from the intake air. The rotation brush includes a shaft extending in the horizontal direction. Further, the rotation brush moves vertically along an upstream surface of the air filter to remove dust from the air filter. The air filter device also includes a dust remover and a dust box. The dust remover accommodates the rotation brush in a rotatable manner. The dust box is coupled to and removed from the front and located under the dust remover. The dust removed by the rotation brush is collected in the dust box under the rotation brush.

In the air filter device of the '021 publication, the pre-filter moves while rubbing its upstream surface against the brush fixed to the middle part of the filter unit. Thus, a large space is required to accommodate the pre-filter. Further, the dust removed from the pre-filter is collected in a housing of the filter unit that accommodates the brush. Thus, the dust removed from the pre-filter may be scattered from around the brush.

In the air filter device of the '837 publication, the air filter is not moved as it is in the '021 publication. Instead, a dust removing means, which includes the rotation brush, dust box, and motor, moves in the vertical direction along the upstream surface of the air filter. Thus, in comparison with the air filter device of the '021 publication, the space required to accommodate the air filter may be reduced. Further, the dust removed by the rotation brush is collected in the dust box, which is located under the rotation brush. This prevents the removed dust from being scattered. However, the air filer device of the '837 publication collects dust in the dust box, which has a dust inlet that is open in the upward direction. Thus, the air filter device of the '837 publication may be applied to certain apparatuses such as an air conditioner but cannot be applied to a video projector that is used in various positions.

### SUMMARY OF THE INVENTION

One aspect of the present invention is a video projector provided with an optical system including a light source lamp having an optical axis. The video projector includes an air inlet through which air is drawn to cool the optical system. The video projector is capable of being oriented in any projection direction within a range of 360 degrees as long as the optical axis of the light source lamp is horizontal. An air filter device is arranged in the air inlet. The air filter device includes an air filer that captures dust from intake air. A cleaner that cleans the air filter. The cleaner includes a rotation brush that rotates about a rotation axis to remove dust from the air filter while moving along an upstream side of the air filter in a direction parallel to the optical axis of the light source lamp. A dust box receives dust removed from the rotation brush. The dust box is an elongated container which extends parallel to the rotation axis of the rotation brush. The dust box includes a dust inlet which opens toward the rotation brush to receive the dust from the rotation brush.

A further aspect of the present invention is an air filter device applicable to a video projector. The video projector includes a light source lamp having an optical axis. The video projector is used in a state in which the optical axis of the light source lamp is horizontal. The air filter device includes an air filter and a cleaner that cleans the air filter. The cleaner includes a rotation brush that rotates about a rotation axis to remove dust from the air filter while moving along an upstream side of the air filter. When the air filter device is coupled to the video projector, the rotation brush moves in a direction parallel to the optical axis of the light source lamp. A dust box receives dust removed from the rotation brush. The dust box is an elongated container which extends parallel to the rotation axis of the rotation brush. The dust box includes a dust inlet which opens toward the rotation brush to receive the dust from the rotation brush.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a video projector using a filter unit according to one embodiment of the present invention;

FIG. 2 is a schematic plan view showing an optical system in the video projector of FIG. 1;

FIG. 3 is a side view showing the video projector of FIG. 1;

FIG. 4A is a side view showing the video projector oriented in an upward projection state;

FIG. 4B is a side view showing the video projector in a ceiling-suspended projection state;

FIG. 4C is a side view showing the video projector in a downward projection state;

FIG. 5 is a perspective view showing the filter unit in a state drawn out of the video projector of FIG. 1 and reversed upside down;

FIG. 6 is a plan view showing the filter unit of FIG. 5;

FIG. 7 is a perspective view showing an automatic cleaner of FIG. 1 arranged at a return position, which is opposite to a standby position;

FIG. 8 is an exploded perspective view showing the filter unit of FIG. 5;

FIG. 9 is a perspective view showing the filter unit in cross-section along line A-A in FIG. 1;

FIG. 10 is a perspective view showing the interior of the automatic cleaner of FIG. 5;

FIGS. 11A and 11B are perspective views showing the automatic cleaner from opposite sides;

FIG. 12 is partial cross-sectional view of the filter unit taken along line B-B in FIG. 6;

FIG. 13 is partial cross-sectional view of the filter unit taken along line C-C in FIG. 6;

FIG. 14 is a cross-sectional view showing the automatic cleaner in a closed state at a position corresponding to line D-D in FIG. 10;

FIG. 15 is a perspective view showing the automatic cleaner of FIG. 11 in a state in which a dust box is pivoted to a removable position;

FIG. 16A is an exploded perspective view of the automatic cleaner in a state in which the dust box is removed;

FIG. 16B is a perspective view of the dust box;

FIGS. 17A, 17B, and 17C are perspective views showing a bearing that supports a pivot shaft of the dust box;

FIGS. 18A and 18B are cross-sectional views of the dust box of FIG. 16A showing a lid that is open at an angle of approximately 90 degrees and 180 degrees;

FIG. 19A is a cross-sectional view showing a screw that fastens the dust box of FIG. 16A;

FIG. 19B is a perspective view showing a guide formed in the lid;

FIG. 20 is a cross-sectional view showing the automatic cleaner in a closed state at a position corresponding to line F-F in FIG. 10;

FIG. 21 is a cross-sectional view showing the dust box taken along line E-E in FIG. 20;

FIG. 22 is a cross-sectional view showing the automatic cleaner in a closed state at a position corresponding to line G-G in FIG. 10;

FIG. 23 is a cross-sectional view showing the automatic cleaner when performing a cleaning operation; and

FIG. 24 is a cross-sectional view showing the automatic cleaner returning to the standby position.

### DETAILED DESCRIPTION OF THE INVENTION

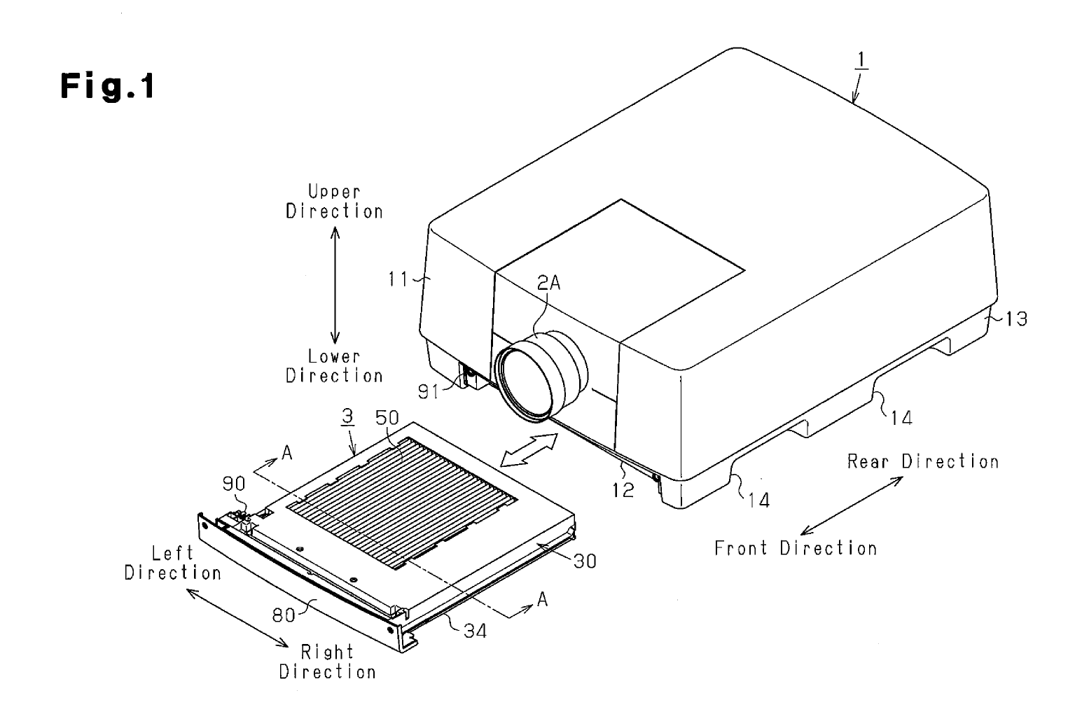

A video projector according to one embodiment of the present invention will now be discussed with reference to the drawings. FIG. 1 shows a state in which the video projector is set upright. In the description hereafter, unless otherwise indicated, the upper, lower, left, right, front, and rear directions are as indicated by the arrows shown in FIG. 1.

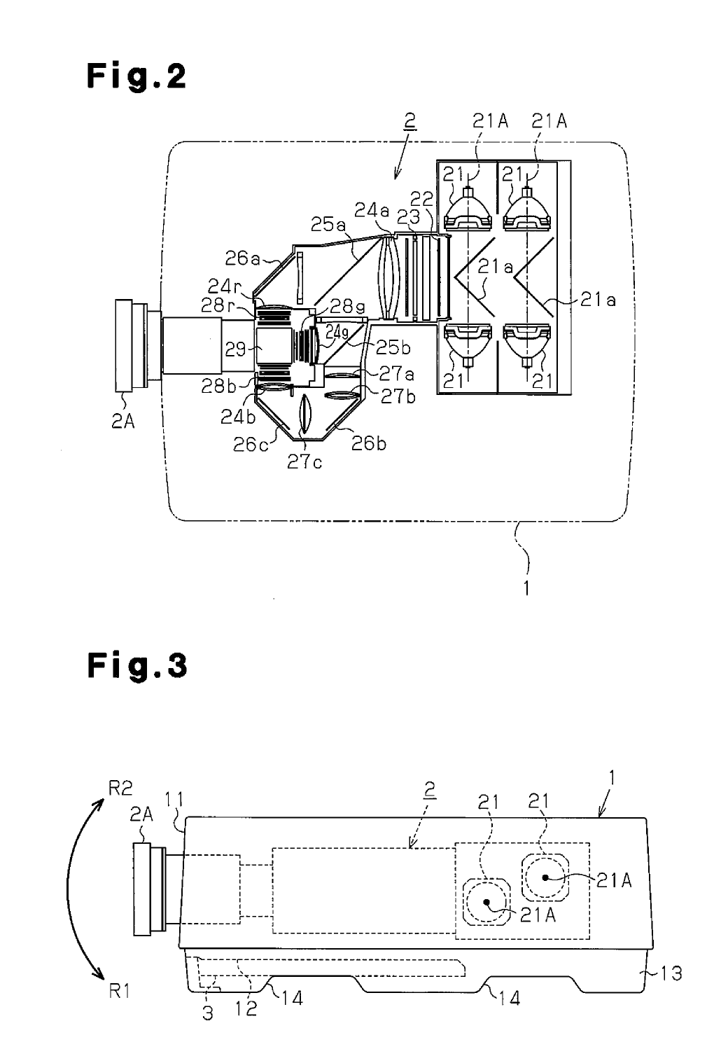

The video projector is a three-LCD type video projector. As shown in the perspective view of FIG. 1, the projector includes a box-shaped outer case 1. The outer case 1 accommodates an optical system 2 such as that shown in FIG. 2. A projection lens 2A extends from a front wall 11 of the outer case 1. A filter unit 3, which serves as an air filter device, is arranged in an air inlet 12 of the outer case 1. The filter unit 3 can be slid out from the front wall 11 of the outer case 1. The filter unit 3 includes an upstream side that is in communication with the exterior of the projector through a plurality of slits 14, which are arranged in left and right side walls 13 of the outer case 1.

Referring to FIG. 2, the optical system 2 includes four light source lamps 21, which serve as a light source and are each formed by a discharge lamp. Each lamp 21 has an optical axis 21A, which is parallel to the front wall 11 of the outer case 1. The illumination light generated by the four light source lamps 21 are combined by optical path changing members 21a and emitted in a predetermined direction (e.g., frontward direction).

An integrator lens 22, polarizing beam splitter 23, and condenser lens 24a guide the illumination light emitted from the lamps 21 to a color separation optical system, which separates the illumination light into three colors of light, namely, red light, green light, and blue light. The color separation optical system includes two dichroic mirrors 25a and 25b, three total reflection mirrors 26a, 26b, and 26c, three relay lenses 27a, 27b, and 27c, and three condenser lenses 24r, 24g, and 24b. Red, green, and blue liquid crystal light valves 28r, 28g, and 28b respectively perform optical modulation on the red light, green light, and blue light. A cross-dichroic prism 29 combines the modulated light into image light, which is emitted from the projection lens 2A. Some of the elements in the optical system 2 require cooling by the cooling air. The elements that are to be cooled are, for example, the lamps 21, the liquid crystal panels and polarization plates of the liquid crystal light valves 28r, 28g, and 28b, and the polarizing beam splitter 23. Of these, the lamps 21 become the hottest.

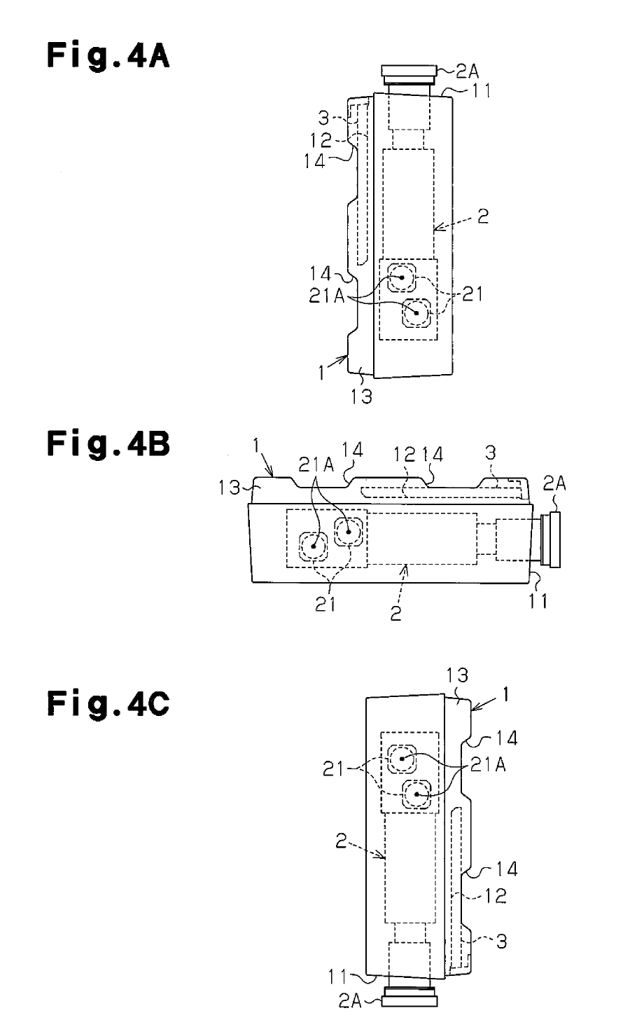

The video projector may be set in an upright projection state as shown in FIG. 3. The video projector may also be set in a state rotated from the state of FIG. 3 in the directions of arrows R1 and R2 so that the optical axis 21A of each lamp 21 is always horizontal. For example, the video projection may be set in an upward projection state shown in FIG. 4A, a suspended projection state shown in FIG. 4B, or a downward projection state shown in FIG. 4C. In this manner, the use of the video projector in a state in which the optical axis 21A of each lamp 21 is always horizontal prevents excessive heating of the lamp 21.

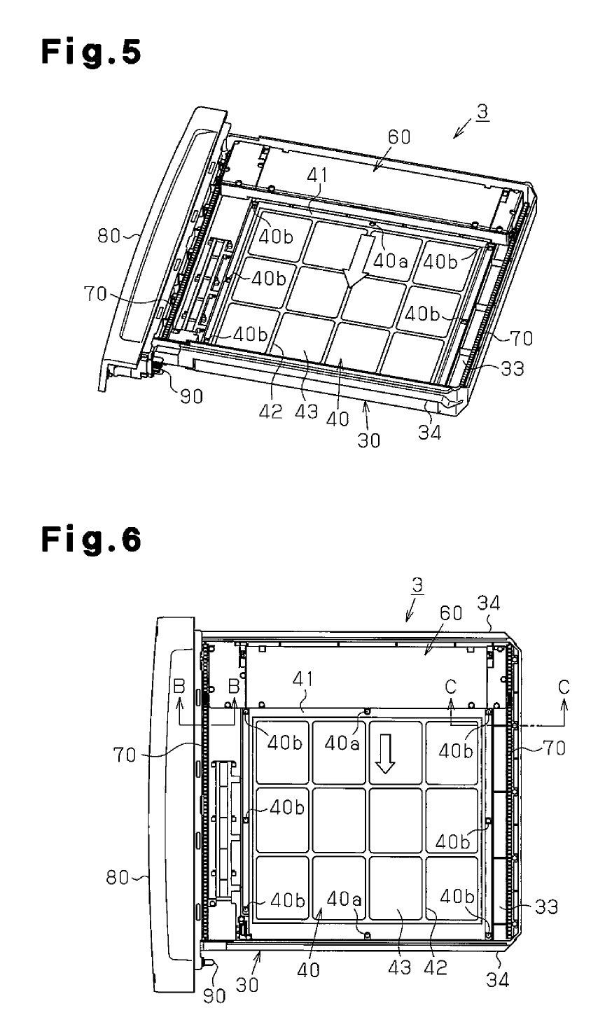

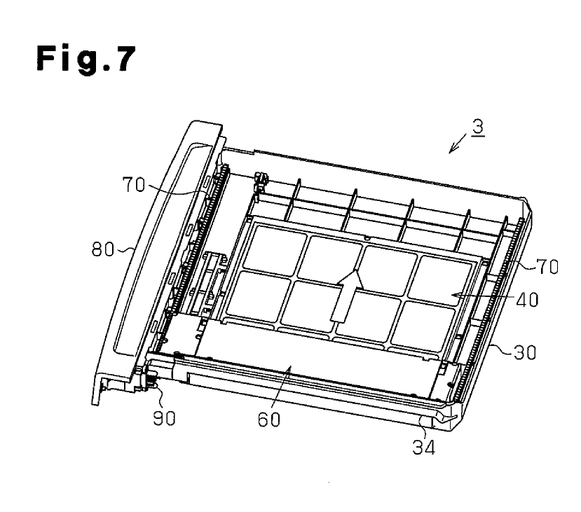

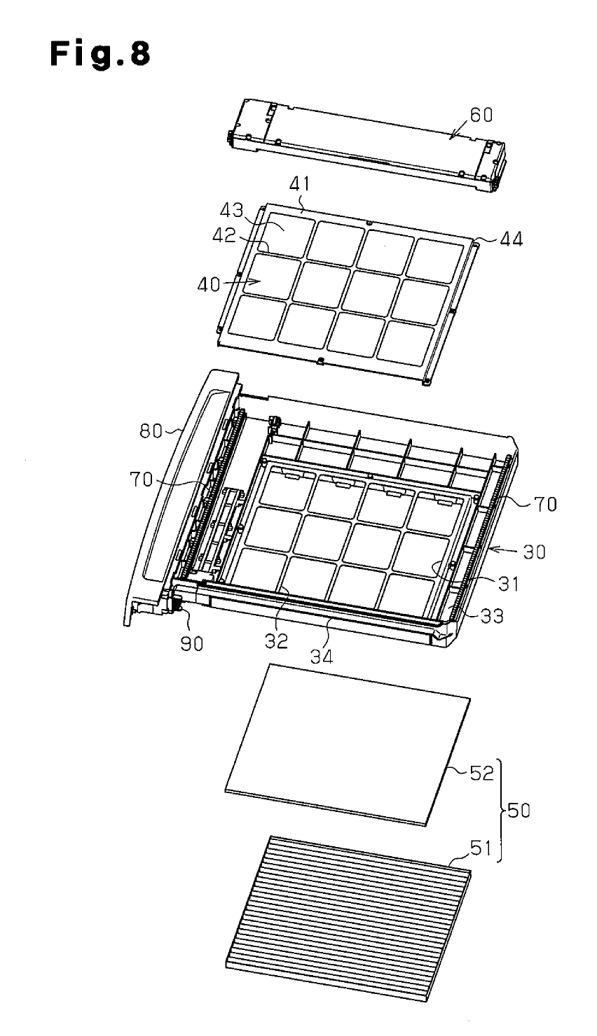

FIG. 1 is a perspective view showing the video projector in a state in which the filter unit 3 is drawn out from the front wall 11. FIG. 5 is a perspective view showing the filter unit 3 reversed upside down from the state of FIG. 1, and FIG. 6 is a plan view of the filter unit 3 in the state of FIG. 5. FIG. 7 is a perspective view showing an automatic cleaner 60 moved to a return position from a standby position of FIG. 5. Referring to the exploded perspective view of FIG. 8, the filter unit 3, which serves as the air filter device, includes a base 30, a first air filter 40, a second air filter 50, the automatic cleaner 60, two racks 70, a handle 80, and a second air filter 50. The first air filter 40, automatic cleaner 60, racks 70, and handle 80 are arranged at an upstream side of the base 30. The second air filter 50 is arranged at the downstream side of the base 30.

The base 30 is a resin molded product. As shown in FIG. 8, the base 30 includes an opening 31, a grid 32, and a frame 33. The opening 31 is arranged in the central part of the base 30 and draws in cooling air. The grid 32 is arranged over the opening 31. The frame 33 surrounds the opening 31. The handle 80 is coupled to the frame 33 of the base 30 near the front wall 11. The automatic cleaner 60 is coupled to the base 30 in a movable manner. As viewed from the front wall 11, when the filter unit 3 is located at the right side on the upstream surface of the base 30 as shown in FIG. 5, the automatic cleaner 60 is arranged at a standby position, which is the initial coupling position. The automatic cleaner 60 is in a non-cleaning state when located at the standby position. The base 30 includes left and right walls each forming a rail 34. When sliding the filter unit 3 into the outer case 1 for coupling from the outer side of the front wall 11, the filter unit 3 slides along the rails 34. The two racks 70 are coupled to the upstream side of the base 30 as shown in FIG. 8. The racks 70 are located at opposite sides of the opening 31 near the front and rear ends of the base 30. The racks 70 are in parallel to the optical axis 21A of each lamp 21 when the filter unit 3 is slid into and coupled to the outer case 1. The automatic cleaner 60 moves along the racks 70.

The first air filter 40 is coupled to the upstream side of the base 30 at a position corresponding to the opening 31. The first air filter 40 serves as an air filter in the present invention.

As shown in FIG. 8, the first air filter 40 includes a rim 41, a grid 42, and a porous filtering member 43, which are molded integrally with one another from a resin material. A filtering surface is defined at the inner side of the rim 41. The grid 42 divides the filtering surface into a plurality of sections. The filtering member 43 captures dust from the air. In the present embodiment, the rim 41 may include a bent portion 44 to increase rigidity and strength. In addition, fasteners fasten the rim 41 of the first air filter 40 to the frame 33 of the base 30 in a direction generally orthogonal to the filtering surface. For example, as shown in FIG. 5, the fasteners may be screws 40a, which are located at the left and right sides, and screws 40b, which are located at the front and rear sides.

The second air filter 50 is coupled to the downstream side of the base 30 in correspondence with the opening 31 of the base 30.

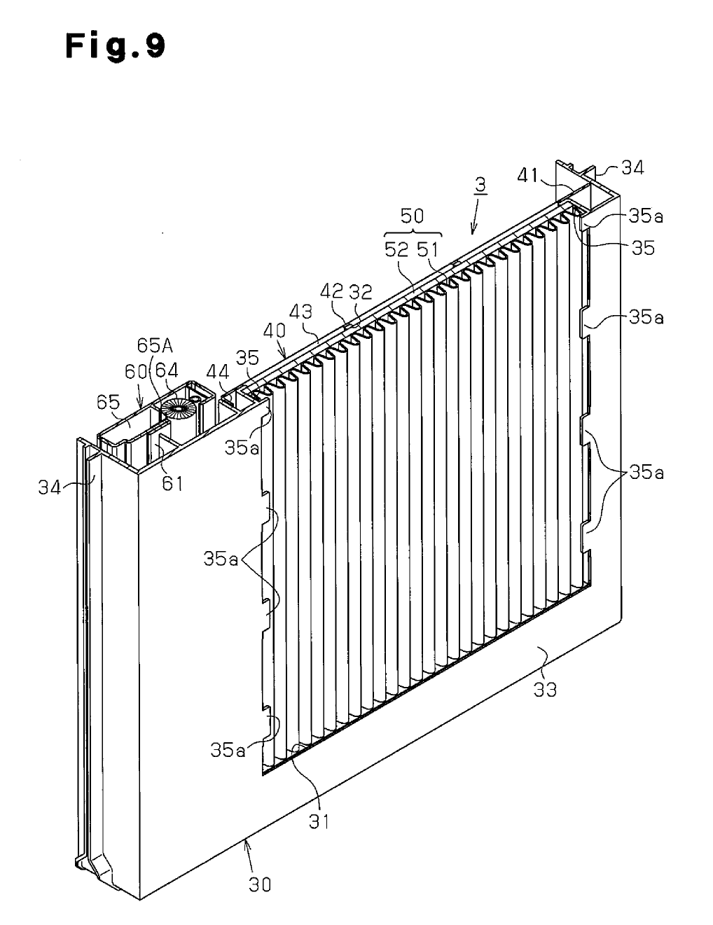

As shown in FIG. 8, the second air filter 50 includes an electrostatic filtering member 51, which includes polymer fibers charged with static electricity, and a urethane sheet 52, which is flat and functions as a cushion. The urethane sheet 52 is located at the downstream side of the frame 33 of the base 30 and the upstream side of the electrostatic filtering member 51. As shown in FIG. 9, the frame 33 of the base 30 includes U-shaped retainers 35, which hold edges of the second air filter 50. The U-shaped retainers 35 include a plurality of holding portions, or tabs 35a, which extend inward from the frame 33 into the opening 31. Accordingly, the upstream side of second air filter 50, which is the urethane sheet 52, is supported in a state abut against the frame 33 of the base 30, and the edges of the second air filter 50 are forced into the U-shaped retainers 35. In this manner, the second air filter 50 is also coupled to the frame 33 of the base 30 in a direction generally orthogonal to the filtering surface.

As shown in FIG. 9, the electrostatic filtering member 51 of the second air filter 50 includes a filtering sheet, which has a plurality of pleats folded in the lateral direction. The electrostatic filtering member 51 captures particles of dust that are finer than the particles of dust captured by the first air filter 40. The urethane sheet 52, which functions as a cushion, facilitates the coupling of the edges of the second air filter 50 to the U-shaped retainers 35.

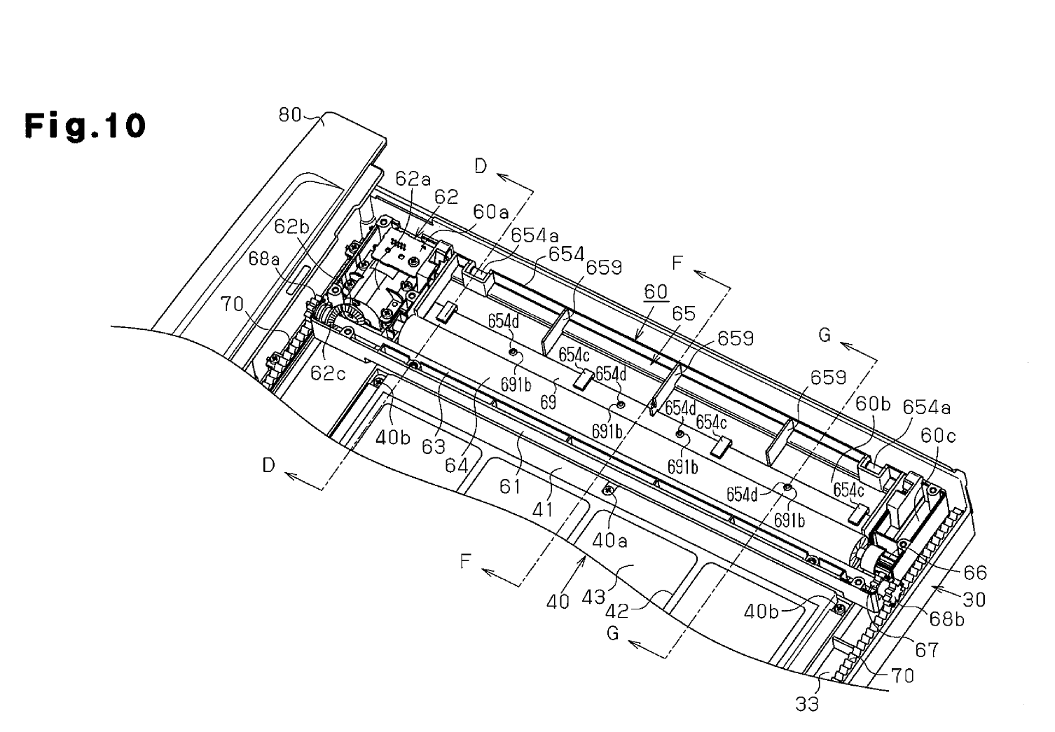

The automatic cleaner 60 serves as a cleaner in the present invention. FIG. 9 shows the automatic cleaner 60 partially in cross-section. FIG. 10 shows the interior of the automatic cleaner 60. The automatic cleaner 60 is arranged at the upstream side of the filter unit 3 and is elongated in a frontward direction of the first air filter 40. The automatic cleaner 60 includes a housing 61, which is a rein molded product. The housing 61 accommodates a driver 62, a transmission shaft 63, a rotation brush 64, a dust box 65, a one-way clutch 66, a spur gear 67, and pinions 68a and 68b. Components such as the rotation brush 64, the dust box 65, and the driver 62 move integrally with the housing 61. As shown in FIG. 10, the automatic cleaner 60 is partitioned into a driver compartment 60a, which accommodates the driver 62, a dust removal compartment 60b, which accommodates a transmission shaft 63, a rotation brush 64, and a dust box 65, and a clutch compartment 60c, which accommodates the one-way clutch 66 and spur gear 67.

The driver 62, which is accommodated in the driver compartment 60a, includes a motor 62a and bevel gears 62b and 62c. The motor 62a includes an output shaft, which extends perpendicular to the longitudinal direction of the housing 61. The bevel gear 62b is arranged on distal end of the output shaft of the motor 62a. The bevel gear 62c is arranged on the transmission shaft 63 in engagement with the bevel gear 62b. Torque is transmitted from the motor 62a to the transmission shaft 63.

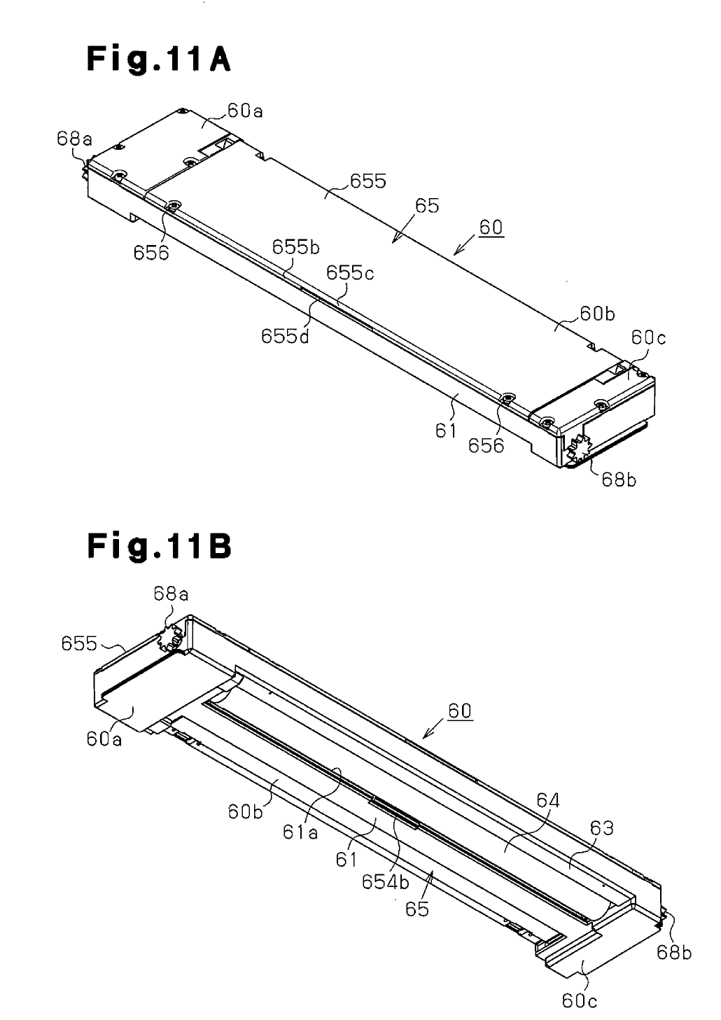

The clutch compartment 60c accommodates a spur gear 67 and the one-way clutch 66. The spur gear 67 is arranged on a rear end of the transmission shaft 63. The one-way clutch 66 is arranged on a shaft 64a of the rotation brush 64. The transmission shaft 63 has two ends projecting outward from the housing 61 as shown in FIGS. 11A and 11B. Pinions 68a and 68b are arranged on each end of the transmission shaft 63 outside the automatic cleaner 60, that is, at the front and rear of the base 30. The pinions 68a and 68b are engaged with the corresponding racks 70, which extend parallel to the optical axes 21A of the lamps 21.

The dust removal compartment 60b has a length that is about the same as that of the left and right sides of the first air filter 40. The transmission shaft 63, rotation brush 64, and dust box 65 are arranged in the dust removal compartment 60b in this order from the side closer to the first air filter 40. The lengths of the transmission shaft 63, rotation brush 64, and dust box 65 are about the same as the left and right sides of the first air filter 40.

Referring to FIG. 10, the motor 62a rotates the transmission shaft 63 through the engagement of the bevel gears 62b and 62c in the driver compartment 60a. The pinions 68a and 68b at the two ends of the transmission shaft 63 are engaged with the corresponding racks 70. The gear mechanism of the pinions 68a and 68b and racks 70 convert rotation of the transmission shaft 63 to linear motion of the automatic cleaner 60. As a result, the automatic cleaner 60, which includes various components arranged in the housing 61 moves parallel to the optical axes 21A of the lamps 21. Thus, as long as the optical axes 21A of the lamps 21 extend in the horizontal direction, the automatic cleaner 60, or the rotation brush 64, constantly moves horizontally regardless of the video projector being oriented in any one of the projection directions shown in FIGS. 3 and 4.

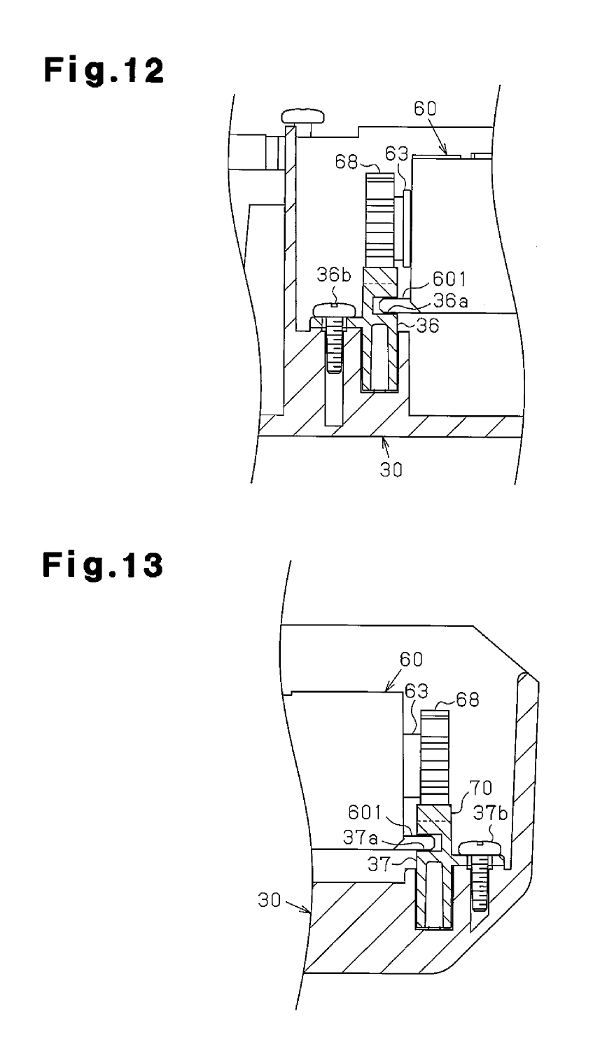

The motor 62a drives the automatic cleaner 60 from the standby position shown in FIG. 5 to the opposite return position shown in FIG. 7. A sensor (not shown) detects the automatic cleaner 60 when moved to the return position of FIG. 7. In response to such detection, the automatic cleaner 60 returns to the standby position. The pinions 68a and 68b are rotated in the counterclockwise direction as viewed from the front wall 11 when the automatic cleaner 60 moves from the standby position of FIG. 5 to the return position of FIG. 7. The pinions 68a and 68b are rotated in the clockwise direction as viewed from the front wall 11 when the automatic cleaner 60 moves from the return position of FIG. 7 to the standby position of FIG. 5. As shown in FIGS. 12 and 13, planar extensions 601 project from front and rear walls of the automatic cleaner 60. Seats 36 and 37 respectively support the two racks 70 of the base 30. Grooves 36a and 37a are respectively formed on side walls of the seats 36 and 37 to receive the extensions 601 in a movable manner. Screws 36b and 37b shown in FIGS. 12 and 13 fix the seats 36 and 37 to the base 30.

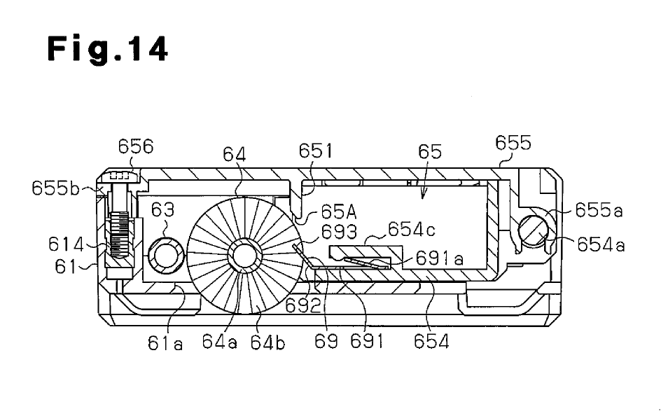

As shown in the cross-sectional view (taken along line D-D in FIG. 10) of FIG. 14, in the automatic cleaner 60, the rotation brush 64 includes a shaft 64a, which is formed from metal or resin, and a brushing member 64b, which is wound around the shaft 64a. The one-way clutch 66 is arranged on the rear end of the shaft 64a as shown in FIG. 10.

As shown in FIG. 14, the rotation brush 64 is formed so that a distal portion of the brushing member 64b extends upward (downward as viewed in FIG. 14) from the dust removal compartment 60b toward the first air filter 40 to remove dust from the first air filter 40. The distal portion of the brushing member 64b slightly projects out of an opening 61a formed in the housing 61. The dust box 65 is formed at the rear of the rotation brush 64 with respect to the direction in which the automatic cleaner 60 moves from the standby position of FIG. 5 to the return position of FIG. 7.

The dust box 65 is an elongated container extending parallel to the axis of the rotation brush 64. Further, the dust box 65 is a resin molded product. A dust inlet 65A is formed in the dust box 65 to receive dust from the rotation brush 64. The dust inlet 65A opens toward the rotation brush 64. The distal portion of the brushing member 64b slightly enters the dust box 65 through the dust inlet 65A.

A dust remover 69, which extends downward (upward as viewed in FIG. 14), is arranged below (above as viewed in FIG. 14) the dust inlet 65A of the dust box 65. The dust remover 69 removes dust from the rotation brush 64. A partition wall 651 is formed below (above as viewed in FIG. 14) the dust inlet 65A to partition the dust box 65 and rotation brush 64. The partition wall 651 prevents dust, which is removed from the rotation brush 64 by the dust remover 69 and collected in the dust box 65, from being scattered out of the dust box 65.

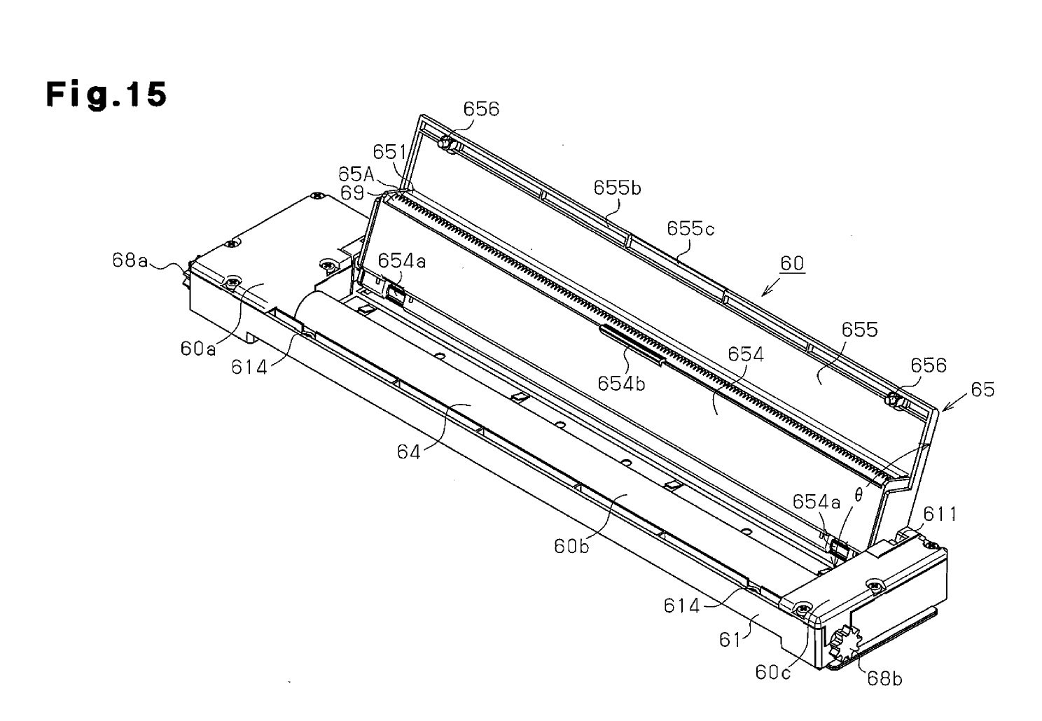

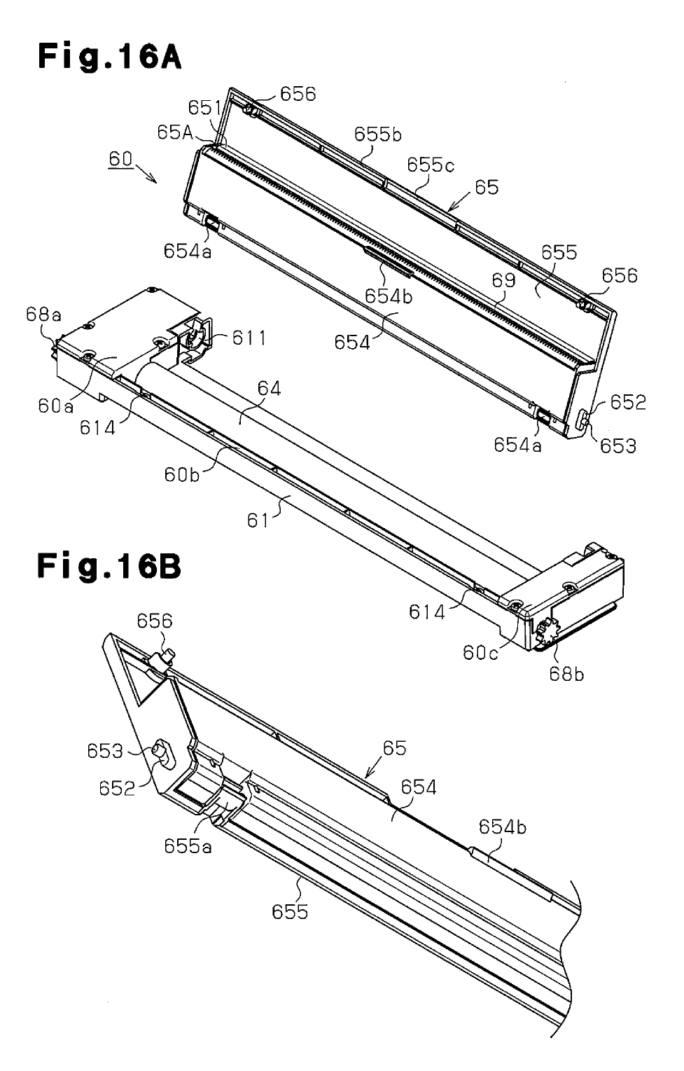

Referring to FIG. 15, the dust box 65 includes two longitudinal ends that are rotatably supported by the housing 61 at the side farther from the rotation brush 64. In a state in which the upstream side of the automatic cleaner 60 faces upward, the dust box 65 is pivotal by a predetermined angle θ to a position at which the dust inlet 65A faces upward. In FIG. 15, angle θ represents an upper limit value (predetermined angle) for the pivot angle of the dust box 65 and is, for example, 110 degrees. The predetermined angle θ is determined so that when the dust box 65 is pivoted by the predetermined angle θ, the dust box 65 does not easily return to its original position. However, when the predetermined angle θ is too large, dust easily escapes from the dust inlet 65A. Accordingly, the predetermined angle θ is not limited to 110 degrees and may be in the range of 105 to 120 degrees. Referring to FIGS. 16A and 16B, the dust box 65 can be removed from the filter unit 3 when pivoted by the predetermined angle θ. It is preferable that the dust box 65 be coupled to and removed from the filter unit 3 within a predetermined angular range in which the dust box 65 faces upward. This improves workability. The preferable angular range is the pivotal angle from approximately 80 degrees to the predetermined angle θ.

To enable pivoting of the dust box 65 and allow for the dust box 65 to be coupled to and removed from the housing 61, the two longitudinal ends of the dust box 65 each include an elliptic pivot restriction portion 652, which restricts the pivoting of the dust box 65 at the predetermined angle θ, and a pivot shaft 653, which projects from the pivot restriction portion 652. As shown in FIGS. 15 and 16, the housing 61 includes bearings 611, which support the corresponding pivot shafts 653 of the dust box 65.

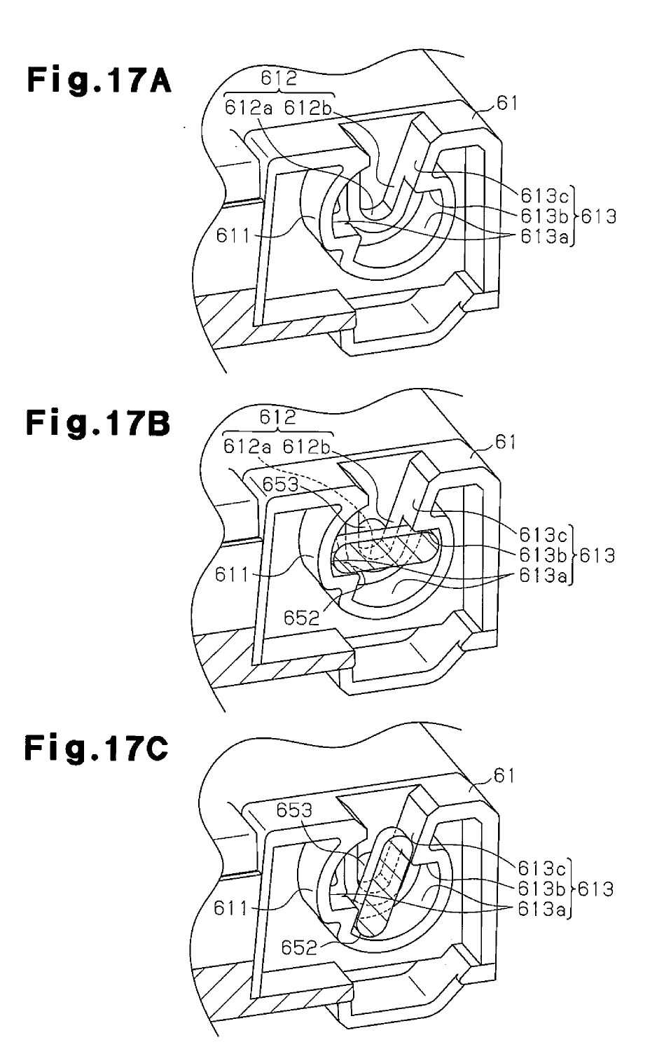

As shown in FIG. 17, each bearing 611 includes a shaft support 612, which receives the corresponding pivot shaft 653, and a pivot control portion 613, which receives the pivot restriction portion 652. The shaft support 612 includes a semicircular receptacle 612a, which supports the fitted pivot shaft 653, and a guide 612b, which opens upward as viewed in the drawing from the semicircular receptacle 612a. The pivot control portion 613 cooperates with the pivot restriction portion 652 to control the pivot angle of the dust box 65 and the coupling and removal of the dust box 65. The pivot control portion 613 includes a cylindrical wall 613a, a restriction wall 613b, and a guide wall 613c. The cylindrical wall 613a permits pivoting of the pivot restriction portion 652. The restriction wall 613b restricts removal of the pivot shaft 653 from the bearing 611 during cleaning. When the pivot shaft 653 is pivoted to the predetermined angle θ, the guide wall 613c restricts further pivoting and guides the pivot restriction portion 652 upward as viewed in the drawing.

As shown in the cross-sectional view of FIG. 14, the dust box 65 includes a bottom piece 654, which is arranged closer to the air filter 40, and a lid 655. The lid 655 is coupled to the bottom piece 654 so that the lid 655 is pivotal to open the dust box 65.

The bottom piece 654 includes an end located at a position corresponding to the dust inlet 65A of the dust box 65. The lid 655 includes an end located beyond the dust inlet 65A and to an edge of the housing 61 to cover the rotation brush 64 and the transmission shaft 63.

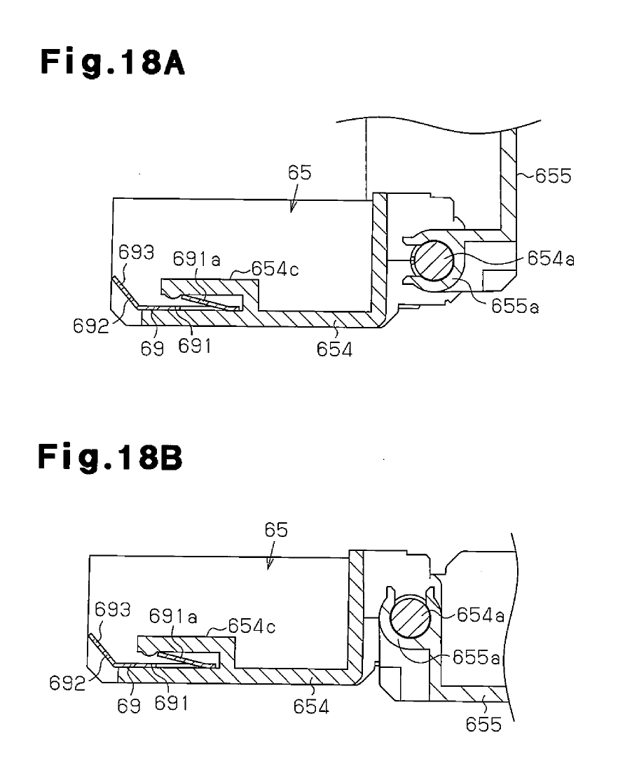

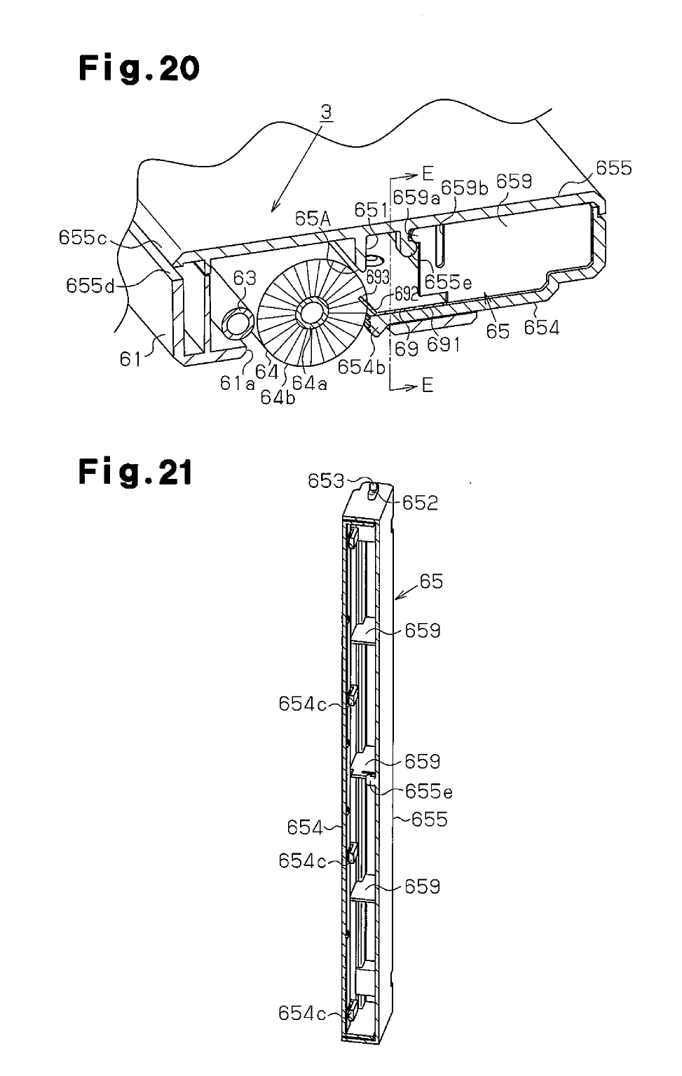

As shown in FIGS. 14 and 15, the distal end of the lid 655 forms a bent piece 655b, which comes into contact with the top of the housing 61. As shown in FIG. 20, a grip 655c is formed at the longitudinally middle part of the bent piece 655b by bending the distal end of the lid 655 for a smaller amount than the other parts of the bent piece 655b. The formation of the grip 655c produces a gap 655d between the grip 655c and the top of the housing 61. One's fingers may be inserted into the gap 655d to facilitate pivoting of the dust box 65. Referring to FIG. 16, the lid 655 is pivotally supported at two locations by the bottom piece 654 at the side farther from the rotation brush 64. As shown in FIG. 18, such a support structure includes a shaft 654a, which is arranged on the bottom piece 654, and a hinge 655a, which is pivotally and elastically engaged with the shaft 654a. The hinge 655a is formed in the lid 655. In a state in which the dust box 65 is removed from the housing 61, the lid 655 is pivotal from the closed position by 180 degrees to a fully open position. The pivot restriction portions 652 and the pivot shaft 653 are formed on the lid 655.

As shown in FIG. 14, fastening screws 656 fasten the distal portion of the lid 655 to the housing 61 so that the lid 655. The housing 61 includes threaded portions 614, which are insert molded integrally from resin with the housing 61. The fastening screws 656 are fastened to the threaded portions 614 of the housing 61 except when the dust box 65 is removed from the housing 61. This prevents pivoting of the dust box 65. As shown in FIG. 20, the housing 61 includes the opening 61a, through which the rotation brush 64 extends toward the first air filter 40. A projection 654b, which projects toward the housing 61, is formed at the middle of the distal end of the bottom piece 654. The projection 654b is engaged with the wall defining the opening 61a.

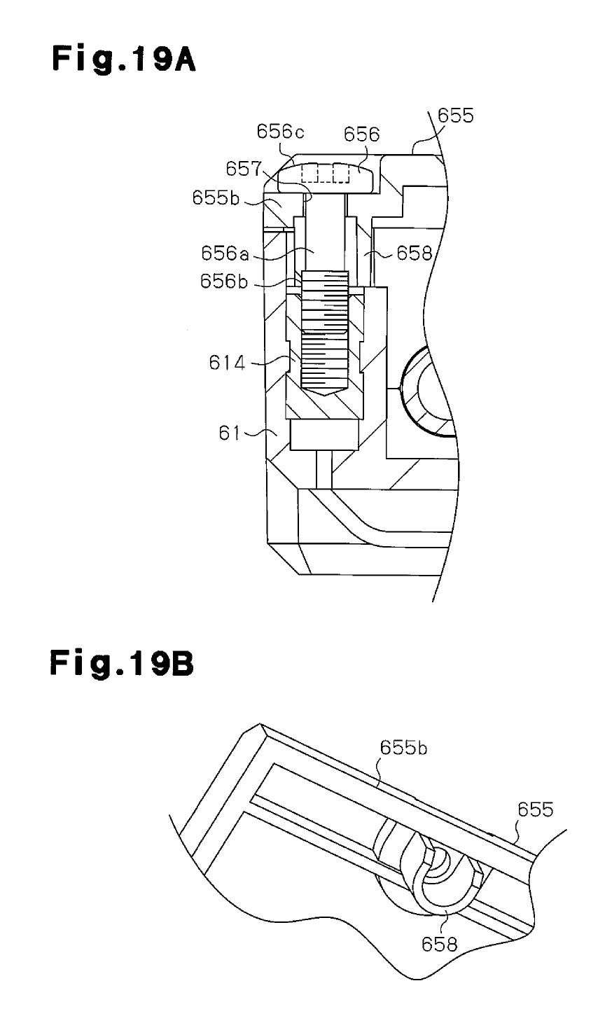

As shown in the enlarged view of FIG. 19, each fastening screw 656 includes a shaft 656a and a head 656c. A threaded portion 656b is formed at the lower part of the shaft 656a. The diameter at the threaded portion 656b is greater than the diameter of the shaft 656a near the head 656c. A hole 657 is formed for each fastening screw 656 in the lid 655 to receive the threaded portion 656b. The diameter of the hole 657 is generally the same as the threaded portion 656b. To fit the fastening screw 656 into the threaded portion 656b of the hole 657, the fastening screw 656 should be rotated and fastened to the threaded portion 656b. Subsequent to the fitting of the threaded portion 656b into the hole 657, the fastening screw 656 does not easily fall out of the hole 657 and become lost. As shown in FIG. 19, a semi-cylindrical guide 658 is formed on the lid 655 to guide the fastening screw 656 to the threaded portion 614.

As shown in FIG. 10, the dust box 65 includes three partition plates 659, which are formed integrally with the bottom piece 654. The partition plates 659 extend parallel to the direction in which the rotation brush 64 moves (i.e., the direction parallel to the optical axes 21A of the lamps 21). As shown in FIG. 20, an engagement projection 655e extends from the inner surface at the middle of the lid 655. A tab 659a is formed on a distal end of the middle partition plate 659 to engage the engagement projection 655e. To facilitate elastic engagement of the engagement projection 655e with the tab 659a, a slit 659b is formed at a position separated from the tab 659a. In this manner, the engagement projection 655e of the lid 655 elastically engages the tab 659a of the middle partition plate 659 so that the lid 655 keeps the bottom piece 654 in a closed state. This integrates the lid 655 with the bottom piece 654.

In this example, the three partition plates 659 divide the dust box 65 into four sections. For example, when the video projector is oriented in an upward projection direction, the dust box 65 is arranged extending in the vertical direction as shown in FIG. 21. However, since the dust box 65 is divided into four sections, the dust removed from the rotation brush 64 and collected in the dust box 65 does not concentrate at one side of the dust box 65. The partition plates 659 also act to reinforce of the dust box 65.

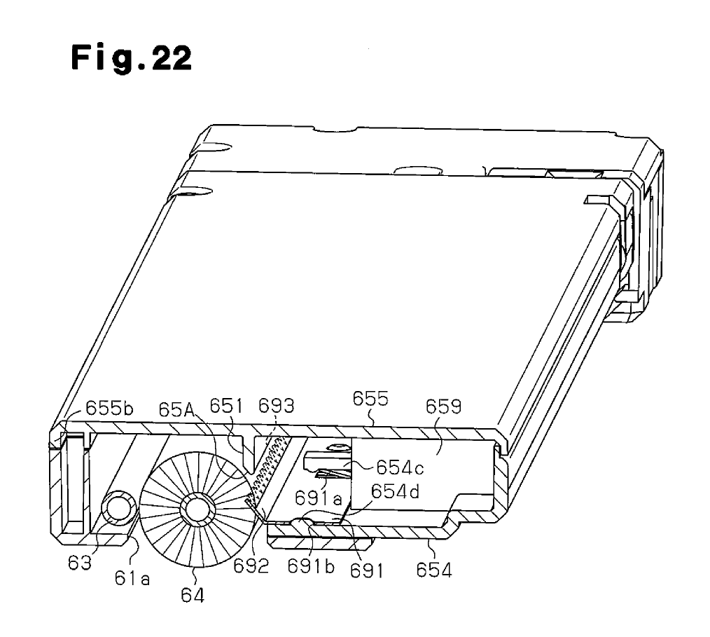

As shown in FIG. 22, the dust remover 69, which is arranged at the dust inlet 65A of the dust box 65, is a bent member formed from a metal such as stainless steel. The dust remover 69 includes a coupling wall 691, which is parallel to the bottom piece 654, and a sloped wall 692, which is inclined upward from the coupling wall 691 (bottom piece 654). The sloped wall 692 includes a distal portion that defines a comb-shaped portion 693, which cards the rotation brush 64 when a cleaning operation is being performed. More specifically, the comb-shaped portion 693 extends toward the rotation axis of the rotation brush 64. The dust remover 69 is coupled to the bottom piece 654 by two engagement structures. In the first engagement structure, four clips 654c are formed on the bottom piece 654 (refer to FIGS. 10 and 14). Sloped flaps 691a are formed on the coupling wall 691 to engage with the inner surfaces of the corresponding clips 654c. In the second engagement structure, four bushings 654d are formed on bottom piece 654 (refer to FIGS. 10 and 22). Holes 691b, which are engaged with the corresponding bushings 654d, are formed in the coupling wall 691. The two engagement structures located at a number of locations fixes the dust remover 69 to the bottom piece 654.

As shown in FIG. 1, the filter unit 3 includes a connector 90, which is arranged behind the handle 80 and beside the base 30. The connector 90 is connectable to a connector 91 in the outer case 1. The connection of the connectors 90 and 91 electrically connects power supply lines and control lines of the filter unit 3 and the video projector to allow for operation based on commands from an operation unit or control unit of the video projector. When the filter unit 3 is slid into and coupled to the outer case 1, the connector 90 of the filter unit 3 becomes connected to the connector 91 of the outer case 1. In the illustrated example, the connected connectors 90 and 91 are hidden by the handle 80.

An automatic cleaning operation performed by the filter unit 3 will now be discussed.

The filter unit 3 is operated when, for example, a clogging sensor (not shown) detects clogging of the first air filter 40. Although not particularly limited, the clogging sensor detects an increase in the current of a fan motor (not shown) that corresponds to an increase in the air intake resistance caused by clogging of the first air filter 40.

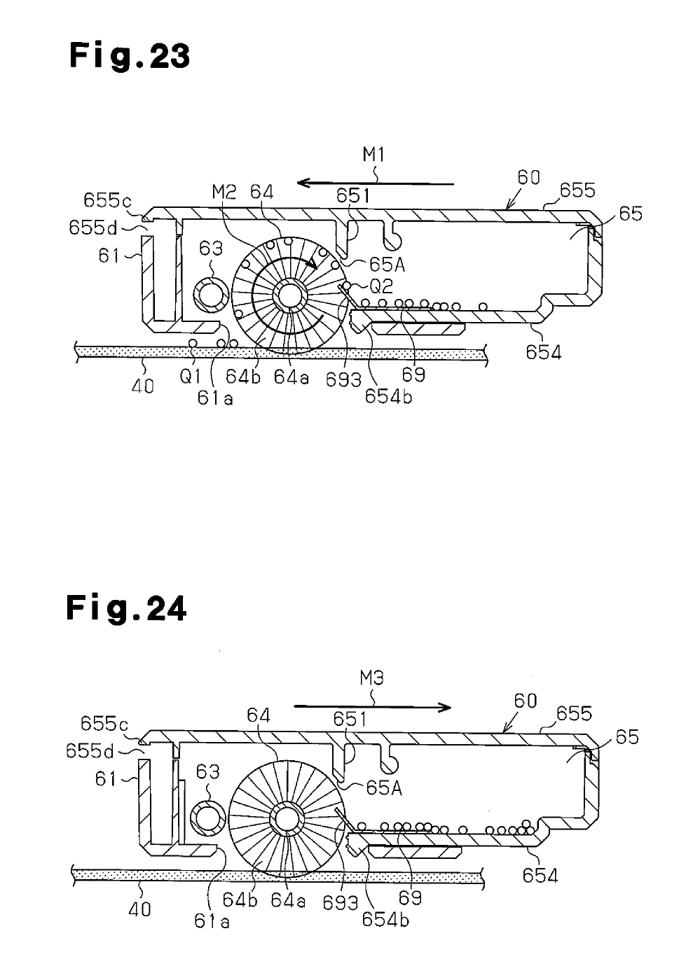

When operating the filter unit 3, the motor 62a is activated to rotate the transmission shaft 63 and the pinions 68a and 68b. This moves the automatic cleaner 60 from the standby position shown in FIG. 5 to the return position shown in FIG. 7. The movement direction is the direction indicated by arrow M1 in FIG. 23 and parallel to the optical axes 21A of the lamps 21. The optical axes 21A remain horizontal regardless of the projection direction of the video projector (refer to FIGS. 3 and 4). Thus, even if the filtering surface of the filter unit 3 is vertical, the movement direction of the automatic cleaner 60 is always horizontal. As a result, even when the projection direction changes as shown in FIGS. 3 and 4A to 4C, the load applied to the motor 62a does not change greatly. This stably drives the automatic cleaner 60.

The rotation brush 64 rotates in the direction of arrow M2 in FIG. 23 while downwardly pressing the first air filter 40. This removes dust particles Q1 from the first air filter 40. The comb-shaped portion 693 of the dust remover 69 at the dust inlet 65A of the dust box 65 removes dust particles Q2 from the rotation brush 64. The dust particles Q2 are collected in the dust box 65. The dust inlet 65A is always open in the movement direction of the rotation brush 64. Thus, during cleaning, the dust inlet 65A is not oriented downward, and the dust removed from the first air filter 40 is not released from the dust box 65.

As the automatic cleaner 60 removes dust from the first air filter 40 and reaches the return position shown in FIG. 7, a sensor (not shown) detects the automatic cleaner 60. This reverses the rotation produced by the motor 62a and moves the automatic cleaner 60 to the standby position shown in FIG. 5. FIG. 24 illustrates the movement of the automatic cleaner 60 to the standby position, and arrow M3 indicates the movement direction. When the automatic cleaner 60 moves to the standby position, reverse rotation of the rotation brush 64 may scatter the dust particles Q2 on the rotation brush 64. Thus, in the present invention, the one-way clutch 66 cuts the transmission of torque from the motor 62a to the rotation brush 64.

The partition plates 659, which extend parallel to the optical axes 21A of the lamps 21, partition the interior of the dust box 65 into a plurality of sections in the longitudinal direction. Thus, the dust removed from the rotation brush 64 is evenly collected in each section partitioned by the partition plates 659. When the video projector is oriented in an upward projection direction or a downward projection direction, the longitudinal direction of the dust box 65 becomes vertical. However, this would not cause dust to be concentrated at one side of the dust box 65. Accordingly, the interior volume of the dust box 65 is effectively used to collect dust. This prolongs the dust disposal cycle of the dust box 65. The partition plates 659 are flat and easy to form. Further, the partition plates 659 act as ribs that reinforce the dust box 65.

Maintenance of the filter unit 3 will now be described.

The first air filter 40 is automatically and repeatedly cleaned through the operation described above. The automatic cleaner 60 significantly reduces the number of times required to clean and replace the first air filter 40 in comparison to when manually cleaning the first air filter 40. Nevertheless, the amount of dust that remains on the first air filter 40 increases when the video projector is used over a long period of time. Thus, the first air filter 40 should be removed and cleaned or replaced with a new one after a certain period elapses. In the present embodiment, maintenance is easily performed on the first air filter 40 as described below.

First, the filter unit 3 is drawn out and removed from the front wall 11 of the video projector. This disconnects the connector 90 of the filter unit 3 and the connector 91 of the base 30 without the need for directly touching the connectors 90 and 91. Thus, connectors and plugs do not have to be manually removed from the filter unit 3.

Then, the drawn out filter unit 3 is oriented in an upside-down position as shown in FIG. 5. In this state, the screws 40a and 40b are unfastened in a direction perpendicular to the filtering surface of the base 30. Thus, the first air filter 40 may be easily removed from the base 30 in a direction perpendicular to the filtering surface without interference from the automatic cleaner 60 so that the first air filter 40 can be properly washed or cleaned. When necessary, the first air filter 40 may be replaced by a new one. The first air filter 40, which is new, washed, or cleaned, is set at a position corresponding to the opening 31 of the base 30 and easily fastened to the base 30 by the screws 40a and 40b so that it does not interfere with the automatic cleaner 60.

To perform maintenance on the second air filter 50 such as washing, cleaning, or replacement, the second air filter 50 may easily be removed from the frame 33 of the base 30 in a direction perpendicular to the filtering surface. For example, the filter unit 3 is removed from the front wall 11 of the video projector as shown in FIG. 1. Then, the edges of the second air filter 50 are pulled out of the U-shaped retainers 35 to remove the second air filter 50 from the base 30. When the second air filter 50, which is new, washed, or cleaned, is coupled to the base 30, the upstream side of the urethane sheet 52 is arranged in contact with and supported by the frame 33 of the base 30. Parts of the edges of the laminated body of the electrostatic filtering member 51 and the urethane sheet 52 are forced into the U-shaped retainers 35. This facilitates the coupling of the second air filter 50 to the base 30. In this manner, the second air filter 50 is easily coupled to and removed from the base 30 without being interfered with by the automatic cleaner 60.

The disposal of the dust collected in the dust box 65 will now be described. The filter unit 3 is removed from the front wall 11 of the video projector. Then, the filter unit 3 is reversed upside down as shown in FIG. 5. The fastening screws 656 shown in FIG. 14 are unfastened. Then, as shown in FIG. 15, the dust box 65 is pivoted to the pivoted angle θ. The dust box 65 is lifted as shown in FIG. 16. This removes the dust box 65 from the filter unit 3 without dust being released from the dust box 65. Since the diameter of each fastening screw 656 at the threaded portion 656b (refer to FIG. 19) is generally the same as the diameter of each hole 657 in the lid 655, the fastening screw 656 does not fall out of the lid 655 and become lost.

Then, the lid 655, which closes the bottom piece 654 of the dust box 65 removed from the filter unit 3, is pivoted as shown in FIG. 18. In this case, the lid 655 may be pivoted until it partially contacts the bottom piece 654. In this embodiment, the lid 655 may be pivoted by 180 degrees. To open the lid 655 in such a manner, the engagement projection 655e of the lid 655 is disengaged from the tab 659a of the middle partition plate 659 in the dust box 65. The disengagement allows the lid 655 to pivot freely relative to the bottom piece 654. When disengaging the engagement projection 655e from the tab 659a, a user holds the longitudinally middle part of the lid 655 with one hand and holds the projection 654b formed at the middle of the distal part of the bottom piece 654 with the other hand to easily open the dust box 65.

In a state in which the dust box 65 is removed from the housing 61, the rotation brush 64 is exposed as shown in FIG. 16. Thus, the rotation brush 64 may be cleaned with a vacuum cleaner or the like.

After completing maintenance on the dust box 65 and the rotation brush 64, the procedures described above are reversed to assemble the dust box 65 and couple the dust box 65 to the housing 61.

To couple the filter unit 3 to the video projector, the filter unit 3 is slid into the video projector from the front wall 11. Normally, open space is provided in front of the video projector to project light. This easily ensures that sufficient space is provided for the coupling and removal of the filter unit 3. When the filter unit 3 is fitted into the video projector, the connector 90, which is located behind the handle 80, and the connector 91, which is coupled to the outer case 1, are automatically connected. This electrically connects the filter unit 3 to the video projector and controls the filter unit 3 in cooperation with the video projector. Thus, the video projector can restart operation.

The filter unit 3 and the video projector of the present embodiment have the advantages described below.

(1) The automatic cleaner 60 moves along the upstream side of the first air filter 40 from the standby position to the return position. This removes dust from the first air filter 40 with the rotation brush 64 in a state in which the first air filter 40 remains coupled to the base 30.

(2) The first air filter 40 does not have to be moved on the base 30 as in the prior art. This allows for a reduction in the spaced used to accommodate the first air filter 40.

(3) The rotation brush 64 moves in a direction parallel to the optical axes 21A of the light source lamp 21. Thus, even when the projection direction of the video projector is changed by 360 degrees in a state in which the optical axes 21A of the lamps 21 are kept horizontal, the rotation brush 64 always moves in the horizontal direction. Further, the dust inlet 65A of the dust box 65 opens toward the movement direction of the rotation brush 64. Thus, the dust inlet 65A is always open in the horizontal direction. Accordingly, dust is not released from the dust box 65. As a result, the filter unit 3 has a stable dust removal capability when the video projector is oriented in any of various positions.

(4) The rotation brush 64 and the dust box 65 move integrally with each other. Thus, the relative positional relationship of the rotation brush 64 and the dust box 65 is always constant. Accordingly, the rotation brush 64 effectively prevents dust from being released from the dust inlet 65A of the dust box 65.

(5) The movement direction of the rotation brush 64 is constantly horizontal. Thus, the weight of the filter unit 3 does not affect the load applied to the motor 62a. Thus, cleaning is stably performed at a stable rotation speed.

(6) The comb-shaped portion 693, which cards the distal portion of the rotation brush 64 during a cleaning operation, is arranged on the dust remover 69 at the dust inlet 65A of the dust box 65. This efficiently removes dust particles Q2 from the rotation brush 64 and easily gathers the removed dust in the dust box 65.

(7) The partition plates 659 partition the interior of the dust box 65 into a plurality of sections in the longitudinal direction of the dust box 65 (i.e., the direction perpendicular to the movement direction of the rotation brush 64). Thus, the dust removed from the rotation brush 64 is evenly collected in each section. Accordingly, when the longitudinal direction of the dust box 65 is vertical, such as when the video projector is oriented in an upward projection direction or a downward projection direction, dust is not concentrated at the lower side of the dust box 65. This prolongs the dust disposal cycle of the dust box 65.

(8) The filter unit 3, which serves as an air filter device, is coupled in a removable manner to the video projector. Accordingly, maintenance, such as the disposal of dust from the dust box 65 and the cleaning of the first air filter 40 and the second air filter 50, may be performed in a state in which the filter unit 3 is removed from the video projector. This facilitates maintenance. Further, the filter unit 3, which serves as an air filter device, is optimal for a video projector that may be oriented in various directions.

(9) The filter unit 3 of the present embodiment is coupled in a removable manner to the video projector from the front wall 11. The projection lens 2A extends from the front wall 11. This ensures that sufficient space is provided for the coupling and removal of the filter unit 3.

It should be apparent to those skilled in the art that the present invention may be embodied in many other specific forms without departing from the spirit or scope of the invention. Particularly, it should be understood that the present invention may be embodied in the following forms.

The automatic cleaner 60 of the embodiment described above moves the rotation brush 64 and dust box 65 integrally with each other. Instead, only the rotation brush 64 may be formed to move as it rotates, and the dust box 65 may be fixed at the standby position. In this case, when the rotation brush 64 returns to the dust box 65, dust may be removed by a dust remover from the rotation brush 64 and collected in the dust box 65. Further, a shutter may close the dust inlet 65A of the dust box 65 when the rotation brush 64 moves away from the dust box 65. The shutter effectively prevents dust from being released from the dust inlet 65A.

The automatic cleaner 60 of the embodiment described above is driven by the motor 62a. Instead, a cleaner, which includes the rotation brush 64 and the dust box 65, may be driven manually. Further, only the rotation brush 64 may be moved and rotated manually. Such a manual operation may be performed from the front wall 11 using a lever coupled to the cleaner. In this case, the lever may be coupled to the coupling portion to drive the cleaner smoothly.

In the embodiment described above, the racks 70 and pinions 68a and 68b are used as a moving mechanism that automatically moves the automatic cleaner 60. However, the moving mechanism is not limited to such a structure. For example, a lead screw may be used to automatically move the automatic cleaner 60.

In the embodiment described above, the partition wall 651 is used to form the dust inlet 65A of the dust box 65. However, the partition wall 651 may be eliminated by providing a smaller gap between the rotation brush 64 and the lid 655.

In the first air filter 40 of the embodiment described above, the rim 41, the grid 42, and the porous filtering member 43, which captures dust from the air, are molded integrally from resin. However, the rim 41, the grid 42, and the porous filtering member 43 may be formed separately and then be adhered to each other.

In the embodiment described above, the first air filter 40 is fastened by screws to the frame 33 extending around the opening 31. However, the first air filter 40 may be slid on and coupled to the frame 33 in any of frontward, rearward, leftward, and rightward directions.

In the embodiment described above, the second air filter 50 is formed by two components, the electrostatic filter 51 and the urethane sheet 52. However, the urethane sheet 52 may be eliminated. Further, instead of just the urethane sheet 52, the second air filter 50 may be entirely eliminated.

In the embodiment described above, the U-shaped retainers 35, which hold the second air filter 50, are formed in parts of each side surrounding the opening 31 of the base 30. However, the U-shaped retainers 35 may be formed entirely on the sides parallel to the folding of each pleat.

In the embodiment described above, the filter unit 3 is operated when the clogging sensor detects clogging of the first air filter 40. However, the filter unit 3 may be automatically operated whenever the video projector ends projection of an image. The filter unit 3 may also be operated periodically or when a cleaning switch is activated.

In the embodiment described above, the optical system 2 is a three-LCD type including the transmission liquid crystal light valves 28r, 28g, and 28b. However, the video projector may use an optical system of a single-LCD type, for example.

In addition to video projectors, such as LCD projectors, the air filter device may be applied to various air conditioning systems such as an air conditioner or a dust collector.

The present examples and embodiments are to be considered as illustrative and not restrictive, and the invention is not to be limited to the details given herein, but may be modified within the scope and equivalence of the appended claims.

1. A video projector comprising:
an optical system including a light source lamp having an optical axis, wherein the video projector includes an air inlet, through which air is drawn to cool the optical system, and is capable of being oriented in any projection direction within a range of 360 degrees as long as the optical axis of the light source lamp is horizontal; and
an air filter device arranged in the air inlet, wherein the air filter device includes:
an air filer that captures dust from intake air; and
a cleaner that cleans the air filter, wherein the cleaner includes:
a rotation brush that rotates about a rotation axis to remove dust from the air filter while moving along an upstream side of the air filter in a direction parallel to the optical axis of the light source lamp; and
a dust box that receives dust removed from the rotation brush, wherein the dust box is an elongated container, which extends parallel to the rotation axis of the rotation brush, and includes a dust inlet, which opens toward the rotation brush to receive the dust from the rotation brush.

2. The video projector according to claim 1, wherein the cleaner includes a motor driven to integrally move the rotation brush and dust box and rotate the rotation brush.

3. The video projector according to claim 1, wherein:
the cleaner includes a dust remover arranged in the dust inlet of the dust box; and
the dust remover includes a comb-shaped portion that extends toward the rotation axis of the rotation brush, wherein the comb-shaped portion cards the rotation brush when the cleaner is performing cleaning.

4. The video projector according to claim 1, wherein the dust box includes a partition that partitions the dust box into a plurality of sections in a direction perpendicular to the direction in which the rotation brush moves.

5. The video projector according to claim 4, wherein the partition is a flat plate and arranged parallel to the direction in which the rotation brush moves.

6. The video projector according to claim 1, wherein the air filter device is formed as a filter unit coupled in a removable manner to the video projector.

7. The video projector according to claim 6, further comprising a projection lens, wherein the filter unit is configured to be slid into and coupled in a removable manner to the video projector from a front wall from which the projection lens extends.

8. An air filter device applicable to a video projector, wherein the video projector includes a light source lamp having an optical axis and is used in a state in which the optical axis of the light source lamp is horizontal, the air filter device comprising:
an air filter; and
a cleaner that cleans the air filter, wherein the cleaner includes:
a rotation brush that rotates about a rotation axis to remove dust from the air filter while moving along an upstream side of the air filter, wherein when the air filter device is coupled to the video projector, the rotation brush moves in a direction parallel to the optical axis of the light source lamp, and
a dust box that receives dust removed from the rotation brush, wherein the dust box is an elongated container, which extends parallel to the rotation axis of the rotation brush, and includes a dust inlet, which opens toward the rotation brush to receive the dust from the rotation brush.

9. The air filter device according to claim 8, wherein the cleaner includes a motor driven to integrally move the rotation brush and dust box and rotate the rotation brush.

10. The air filter device according to claim 8, wherein:
the cleaner includes a dust remover arranged in the dust inlet of the dust box; and
the dust remover includes a comb-shaped portion that extends toward the rotation axis of the rotation brush, wherein the comb-shaped portion cards the rotation brush when the cleaner is performing cleaning.

11. The air filter device according to claim 8, wherein the dust box includes a partition that partitions the dust box into a plurality of sections in a direction perpendicular to the direction in which the rotation brush moves.

12. The air filter device according to claim 11, wherein the partition is a flat plate and arranged parallel to the direction in which the rotation brush moves.
